(19) United States
(12) Patent Application Publication
(10) Pub. No.: US 2022/0195766 A1
(43) Pub. Date: Jun. 23, 2022

(54) CONTAINER LOCKING SYSTEM

(71) Applicant: In-Tech Enterprise Ltd., Kwun Tong (HK)

(72) Inventors: Gordon Christopher Pope, The Peak (HK); Mak Tse, Yuen Long (HK); Jacky Sai Ping Tsang, Shatin (HK)

(21) Appl. No.: 17/127,326

(22) Filed: Dec. 18, 2020

(51) Int. Cl. E05C 19/18; B65D 88/12; B65D 90/54; E05B 39/02

(52) U.S. Cl. CPC E05C 19/186; B65D 88/12; B65D 2401/00; E05B 39/02; B65D 2590/666; B65D 90/54

(57) ABSTRACT

A container chassis coupling device includes a first mounting bracket that has a first locking bar securing element that is configured to secure the first mounting bracket to a first locking bar on a container, and a second mounting bracket that is slidably coupled to the first mounting bracket and that includes a second locking bar securing element that is configured to secure the second mounting bracket to a second locking bar on the container. The container chassis coupling device prevents the first locking bar and the second locking bar from being oriented from a locked orientation to an unlocked orientation. The container chassis coupling device also includes a node mounting device that is coupled to the first mounting bracket or the second mounting bracket and that is configured to couple a node chassis of a node device to the container chassis coupling device.

### FIELD OF THE DISCLOSURE

This disclosure relates generally to containers, and, more particularly, to container locking systems for containers.

### BACKGROUND

Containers may be used for storage, shipping, and packaging of a variety of products. For example, intermediate bulk containers (IBCs), drums, barrels, bottles, and/or other containers are designed for the transport and storage of bulk liquid and granulated substances such as chemicals, food ingredients, solvents, pharmaceuticals, hazardous materials, and/or a variety of other goods and products known in the art. Intermodal containers, often called shipping containers, are designed for use across different modes of transportation (e.g., ship, rail, truck) without unloading the cargo stored within. Containers typically provide one or more openings that allow access to the containers through which the container may be filled with cargo, and/or through which the cargo may be removed. During shipment and storage, these openings may be obstructed with a variety of closures such as, for example, doors, caps, plugs, tops, valves, lids, and other closures. These closures provide many benefits for the container and the product being shipped and/or stored within the container such as, for example, preventing the product within the container from escaping or be removed by unauthorized parties, preventing materials from outside of the container from entering the container and contaminating the product, preventing spoilage, as well as other uses that would be apparent to one of skill in the art.

Conventional closures attempt to provide container security by including seals that, when broken, indicate whether the container has been opened, prior to, or subsequent to filling/packing the container with the product. Due to the nature of some products being shipped in containers, seals may be important for tracking and determining whether the product within the container has been tampered with (e.g., lost, stolen, and/or contaminated) and/or accessed for legitimate purposes. Such conventional container security systems provide the ability to detect whether the container has experienced tampering by visual inspection of the seal. However, these conventional container security systems are subject to circumvention. For example, the seal may be broken, the closure removed, the product in the container replaced, diluted, or stolen (e.g., during shipment), and the closure and the seal then duplicated and replaced on the container such that the tampering with the product or contents of the container goes undetected.

### SUMMARY

In some embodiments in accordance with the present disclosure, a container locking system includes a container that includes a container chassis that defines a container volume and a container opening that is accessible via a first door that includes a first locking bar and a second door that includes a second locking bar; and a container locking device that includes: a container chassis coupling device that includes: a first mounting bracket that includes a first locking bar securing element that is configured to secure the first mounting bracket to the first locking bar; and a second mounting bracket that is slidably coupled to the first mounting bracket via a slidable coupling and that includes a second locking bar securing element that is configured to secure the second mounting bracket to the second locking bar, wherein the container chassis coupling device prevents the first locking bar and the second locking bar from being oriented from a locked orientation to an unlocked orientation when the first locking bar securing element is engaged with the first locking bar, the second locking bar securing element is engaged with the second locking bar, and a bracket lock device is in a lock orientation that prevents slidable movement of the first mounting bracket relative to the second mounting bracket; and a node mounting device that is coupled to the first mounting bracket or the second mounting bracket and that is configured to couple a node chassis of a node device to the container chassis coupling device.

In various embodiments of the container locking system, the container locking device further includes: a node device that includes a node chassis that is coupled to the node mounting device and the node chassis houses: a communication system; a processing system coupled to the communication system; and a memory system that is coupled to the processing system and that includes instruction, that when executed by the processing system, causes the processing system to provide a container engine that is configured to: communicate container system information associated with the container locking system via the communication system.

In various embodiments of the container locking system, the node chassis includes a seal detection sensor that is coupled to the processing system and that is configured to detect a seal tampering event.

In various embodiments of the container locking system, the container locking device further includes: a seal that is coupled to the seal detection sensor and the container locking device such that the seal causes the seal tampering event to be detected by the seal detection sensor when the container locking device is accessed to orientate the container locking device to allow the first locking bar and the second locking bar to transition from the locked orientation to the unlocked orientation.

In various embodiments of the container locking system, the seal includes a breakaway tape that includes a conductive layer electrically coupled to the seal detection sensor, wherein the a least a first portion of the breakaway tape and a first portion of the conductive layer are configured to break away from a second portion of the breakaway tape and a second portion of the conductive layer when a force used to overcome an adhesive bond between the breakaway tape and the container chassis coupling device is applied to the breakaway tape.

In various embodiments of the container locking system, the seal includes a conductive layer electrically coupled to the seal detection sensor, and wherein the seal detection sensor detects the seal tampering event when the conductive layer is disrupted such that the seal detection sensor detects a change in impedance that satisfies a predetermined impedance change threshold of the conductive layer.

In various embodiments of the container locking system, the seal includes an ultraviolet protection layer that is located opposite the seal from an adhesive layer.

In various embodiments of the container locking system, the slidable coupling includes one or more retaining clips that prevent movement of the first mounting bracket to the second mounting bracket in a direction that is orthogonal to a slidable direction.

In various embodiments of the container locking system, the bracket lock device includes a knob on the first mounting bracket that is connected to one or more stoppers and that is configured to engage the one or more stoppers with the second mounting bracket such that the first mounting bracket and the second mounting bracket are in a lock orientation that prevents the slidable movement of the first mounting bracket relative to the second mounting bracket when the knob is in a first orientation and is configured to disengage the one or more stoppers with the second mounting bracket such that the first mounting bracket and the second mounting bracket are in an unlock orientation that enables the slidable movement of the first mounting bracket relative to the second mounting bracket when the knob is in a second orientation.

In various embodiments of the container locking system, the node mounting device includes a node release that is configured to disengage a node from the node mounting device when activated.

In various embodiments of the container locking system, the node mounting device includes a node mounting device cover that when in a closed position defines a seal aperture with the node mounting device to receive a seal end of a seal for electrically coupling with a node device.

In some embodiments in accordance with the present disclosure a container locking device includes a container chassis coupling device that includes: a first mounting bracket that includes a first locking bar securing element that is configured to secure the first mounting bracket to a first locking bar on a container; and a second mounting bracket that is slidably coupled to the first mounting bracket via a slidable coupling and that includes a second locking bar securing element that is configured to secure the second mounting bracket to a second locking bar on the container, wherein the container chassis coupling device prevents the first locking bar and the second locking bar from being oriented from a locked orientation to an unlocked orientation when the first locking bar securing element is engaged with the first locking bar, the second locking bar securing element is engaged with the second locking bar, and a bracket lock device is in a lock orientation that prevents slidable movement of the first mounting bracket relative to the second mounting bracket; and a node mounting device that is coupled to the first mounting bracket or the second mounting bracket and that is configured to couple a node chassis of a node device to the container chassis coupling device.

In various embodiments of the container locking device, the slidable coupling includes one or more retaining clips that prevent movement of the first mounting bracket to the second mounting bracket in a direction that is orthogonal to a slidable direction.

In various embodiments of the container locking device, the bracket lock device includes a knob on the first mounting bracket that is connected to one or more stoppers and that is configured to engage the one or more stoppers with the second mounting bracket such that the first mounting bracket and the second mounting bracket are in a lock orientation that prevents the slidable movement of the first mounting bracket relative to the second mounting bracket when the knob is in a first orientation and is configured to disengage the one or more stoppers with the second mounting bracket such that the first mounting bracket and the second mounting bracket are in an unlock orientation that enables the slidable movement of the first mounting bracket relative to the second mounting bracket when the knob is in a second orientation.

In various embodiments of the container locking device, the first locking bar securing element includes a first longitudinal securing element that prevents the first locking bar securing element from being moved along a longitudinal axis of the first locking bar, and wherein the second locking bar securing element includes a second longitudinal securing element that prevents the first locking bar securing element from being moved along the longitudinal axis of the first locking bar.

In some embodiments in accordance with the present disclosure a container seal includes: a breakaway tape that includes: an adhesive layer; a body layer that is coupled to the adhesive layer; and a conductive layer that is at least one of being disposed between the body layer and the adhesive layer, disposed within the body layer or adhesive layer, or coupled to the body layer such that the body layer is between the conductive layer and the adhesive layer, wherein the body layer includes a material that is configured to cause a first portion of the body layer to break away from a second portion of the body layer when a force to overcome an adhesive bond between the adhesive layer and a surface to which the breakaway tape is configured to adhere to is applied to the breakaway tape.

In various embodiments of the container seal, the breakaway tape further includes an ultraviolet resist layer that provided opposite the body layer of the breakaway tape from the adhesive layer such that the body layer and the conductive layer are between the adhesive layer and the ultraviolet resist layer, wherein the ultraviolet resist layer is configured to prevent degradation of the breakaway tape from ultraviolet radiation.

In various embodiments of the container seal, the conductive layer is coupled to one or more electrical contacts that are exposed via the adhesive layer.

In various embodiments of the container seal, the conductive layer is configured such that the conductive layer provides a first impedance detectable via the one or more electrical contacts and the breakaway tape is adhered to a surface, and a second impedance detectable via the one or more electrical contacts when the breakaway tape is at least one of bent, ripped, drilled, or compressed.

In various embodiments of the container seal, the breakaway tape further comprises a liner layer that is coupled to the adhesive layer and a force required to remove the liner layer from the adhesive layer is less than the force that causes the first portion of the body layer to break away from the second portion of the body layer.

### BRIEF DESCRIPTION OF THE DRAWINGS

FIG. 1A is a perspective view illustrating an embodiment of a container locking system.

FIG. 1B is a perspective, closeup view of the container locking system illustrating an embodiment of a container locking device on the container of the container locking system of FIG. 1.

FIG. 2A is a front view illustrating an embodiment of the container chassis coupling device included in the container locking device of FIGS. 1A and 1B.

FIG. 2B is a perspective, rear view illustrating an embodiment of the container chassis coupling device included in the container locking device of FIGS. 1A and 1B.

FIGS. 3A and 3B are perspective views of a slidable coupling on the container chassis coupling device of FIGS. 2A and 2B.

FIG. 4A is a perspective view illustrating an embodiment of a bracket lock device in an unlock orientation that is included on the container chassis coupling device of FIGS. 2A and 2B.

FIG. 4B is a perspective view illustrating an embodiment of a bracket lock device in the unlock orientation in relation to the container chassis coupling device of FIGS. 2A and 2B.

FIG. 4C is a perspective view illustrating an embodiment of a bracket lock device in a lock orientation that is included on the container chassis coupling device of FIGS. 2A and 2B.

FIG. 4D is a perspective view illustrating an embodiment of a bracket lock device in the lock orientation in relation to the container chassis coupling device of FIGS. 2A and 2B.

FIG. 5 is a perspective view of a node mounting device on the container chassis coupling device of FIGS. 2A and 2B.

FIG. 6 is a perspective view illustrating another embodiment of the container chassis coupling device included in the container locking device of FIGS. 1A and 1B.

FIG. 7A is a perspective view illustrating an embodiment of a node device included in the container locking device of FIGS. 1A and 1B.

FIG. 7B is a schematic view illustrating an embodiment of the node device included in the container locking device of FIGS. 1A and 1B.

FIG. 8A is a top view illustrating an embodiment of a seal included in the container locking system of FIGS. 1A and 1B.

FIG. 8B is a bottom view illustrating an embodiment of the seal included in the container locking system of FIGS. 1A and 1B.

FIG. 8C is a cross-sectional view along the plane C-C illustrating an embodiment of the seal included in the container locking system of FIGS. 1A and 1B.

FIG. 8D is a cross-sectional view along the plane D-D illustrating an embodiment of the seal included in the container locking system of FIGS. 1A and 1B.

FIG. 9 is a perspective view illustrating an embodiment of a top wall of a container included in a container system that includes a container closure, a container closure node system, and the seal of FIGS. 8A, 8B, and 8C.

FIG. 10 is a flow chart illustrating an embodiment of a method of coupling a container locking device system to a container.

FIG. 11 is a flow chart illustrating an embodiment of a method for providing container security.

Embodiments of the present disclosure may be understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure include a container locking system, as well as methods for coupling a container locking device to a container and performing container security that may be used to track access to a container and its contents. As discussed above, existing seals and locking systems for containers do not prevent tampering with the containers and products provided within those containers, as it has been found that seals and locking systems are easily reproduced and replaced on tampered-with containers such that it is difficult for legitimate parties (e.g., a container manufacturer, a container packer, a container transporter, a container end user, and other parties) associated with the container to detect tampering with the closure and/or seal. Furthermore, some industries may require that access to the container volume be tracked during the lifecycle of the container and conventional seals and locking systems lack tracking capabilities.

As would be appreciated by one of skilled in the art, intermodal containers may be shipped across the globe where the intermodal container experiences many environmental conditions, is loaded and unloaded from various transportation systems (e.g., trains, ships, trucks, etc.), stored and stacked on other intermodal containers without having to unpack or pack the cargo within those containers. Intermodal containers may include a set of door walls that are typically located at the front of the container and make up the front wall of the intermodal container. The door walls may provide the closure for the intramodal container that provides an opening in the intermodal container to provide access to an intermodal container volume in which cargo is stored. Thus, when adding a closure security system and node devices, such as those developed by some of the inventors of the present disclosure, and that are described in the U.S. Pat. No. 10,538,371 and that are described in U.S. patent application Ser. No. 16/451,879, filed on Jun. 25, 2019, entitled “Container Security System,” the disclosures of which are incorporated by reference herein in their entirety and that provides for the detection of whether a container closure (e.g., the door wall) and/or a container (e.g., the intermodal container) has experienced a container system event (e.g., a tamper event), the intermodal container doors and the lifecycle of the intermodal container is taken into consideration.

In various embodiments of the present disclosure, a container locking device is disclosed. The container locking device may include a container chassis coupling device that couples the container locking device to a container. The container chassis coupling device may be coupled to one or more container doors that provide access to a container opening to a container, (e.g., an intermodal container). However, one of skill in the art in possession of the present disclosure will recognize that other container closures will benefit from the teachings of the present disclosure. For example, other opening/closing mechanisms may benefit such as windows, caps, closure fittings, and/or any other opening mechanism that would be apparent to one of skill in the art of the present disclosure. The container chassis coupling device may include a plurality of bracket members that each include a respective locking bar securing element. Each locking bar securing element is configured to engage with a locking bar included on a respective container door. The container locking device may be configured to prevent the locking bars that are engaged with slots on the container from being moved into a disengaged orientation that allows the doors to be opened.

The container locking device may also include a node device. The node device may be coupled to one of the bracket members via a node device securing member. In some embodiments, the node device may be detachable from the node device securing member via a node device release member. In some embodiments, the node device and the container chassis coupling device are configured such that, when engaged with the container, the node device chassis is substantially adjacent a door of the container chassis such that the node device may monitor a node/container presence of the node device in relation to the container chassis via one or more sensors included on or in the node device.

In various embodiments, the node device includes a power source, at least one sensor, a communication system that may include one or more types of communication interfaces, and a processing system. The node device may also include a memory system that is coupled to the processing system and that includes instruction, that when executed by the processing system, causes the processing system to provide a container engine that detects, via the at least one sensor, that a container system event has occurred and provides, via the communication system, a container system event notification for the container system event. For example, the container locking device may include a seal that requires removal before the container locking device can be removed from the doors of the container. The seal of the present disclosure may include a destructible tape that may be formed on the container closure coupling device and the node device. The destructible tape may include a conductive layer that can be monitored by the node device to detect any changes in conductivity, impedance, and/or signals that indicate that a tamper event or other security event. The destructible tape may be made of a material that experiences a plastic deformation or fracture when there is an attempt to remove the destructible tape form the container closure coupling device. As such, the seal cannot easily be removed and replaced without detection as any attempt to replace the tape may result in a different impedance in the conductive layer, signature, or tape identifier that is provided by the destroyed tape and the destroyed tape may provide visual cues that the seal has been tampered with. As such, the container locking device of the present disclosure may provide relative easy and quick attachment and detachment of the container locking device and a node device that provides security to a container.

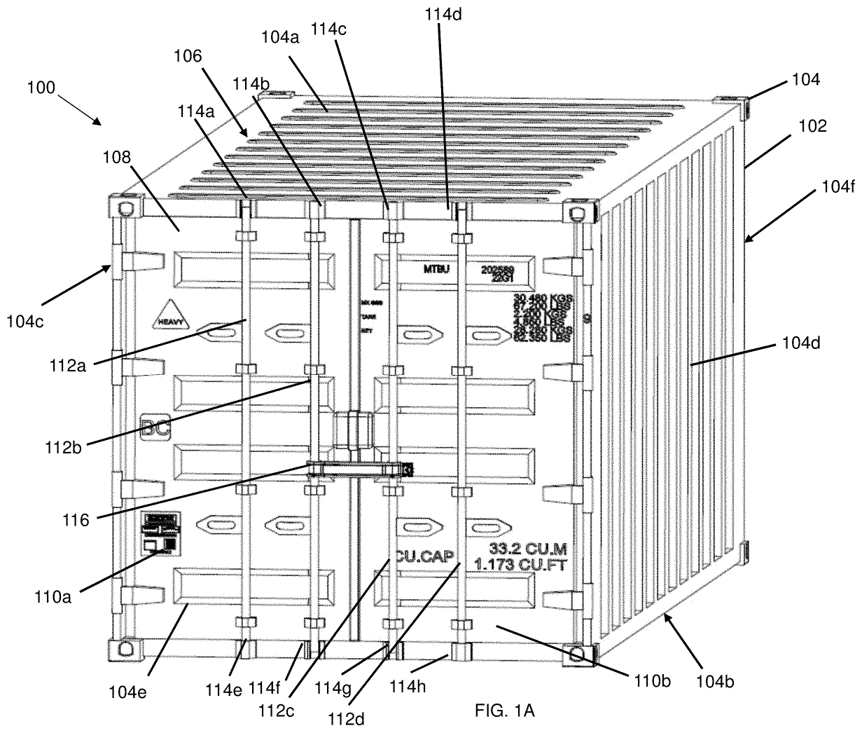

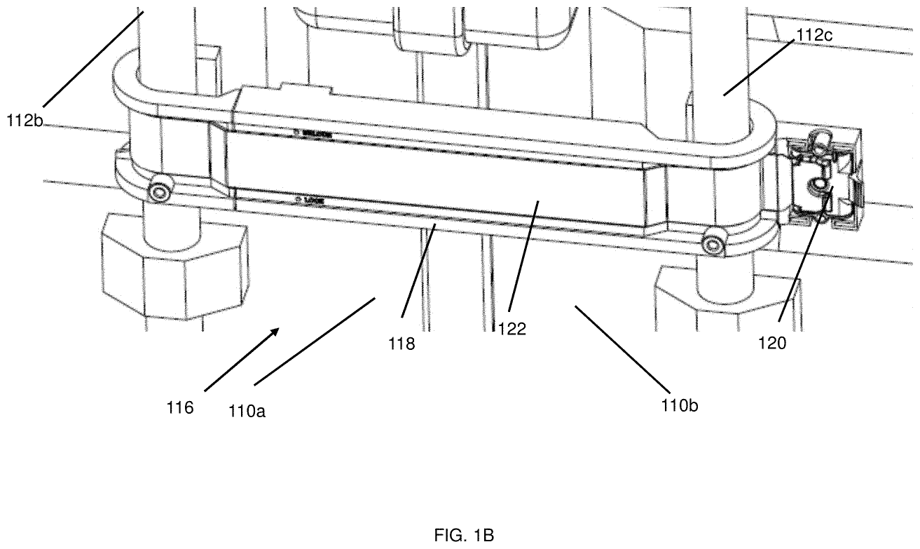

Referring now to FIGS. 1A and 1B, an embodiment of a container locking system 100 is illustrated. The container locking system 100 includes a container 102 having container chassis 104 that includes a top wall 104a, a bottom wall 104b that is located opposite the container chassis 104 from the top wall 104a, and a pair of side walls 104c and 104d that are located opposite the container chassis 104 from each other and that extend between the top wall 104a and the bottom wall 104b. The container chassis 104 may include a front wall 104e that extends between the top wall 104a, the bottom wall 104b, and the side walls 104c and 104d, and a rear wall 104f that that is located opposite the container chassis 104 from the front wall 104e and that extends between the top wall 104a, the bottom wall 104b, and the side walls 104c and 104d. A container volume 106 is defined by the container chassis 104 by the top wall 104a, the bottom wall 104b, the side walls 104c and 104d, the front wall 104e, and the rear wall 104f. In the illustrated embodiment, the front wall 104e defines a container aperture 108 and the front wall 104e may include one or more doors (e.g., a door 110a and a door 110b). The door 110a may be pivotally coupled to the side wall 104c and/or the door 110b may be pivotally coupled to the side wall 104d. Each door may include one or more locking bars (e.g., a locking bar 112a and a locking bar 112b on the door 110a and a locking bar 112c and a locking bar 112d on the door 110b). The locking bars 112a-112d may be vertically orientated and may be moved vertically to be placed into slots (e.g., slots 114a-114h) when the doors 110a and/or 110b are pivoted to a closed position that prevents the door 110a and/or 110b from pivoting to an open position. While a specific example of the container 102 is illustrated and described below (e.g., an intermodal container), one of skill in the art will recognize that the teachings of the present disclosure will be beneficial to container systems including a variety of containers (e.g., trunks, drums, barrels, bottles, boxes, and/or other containers) and/or other container apertures that may be on any of the walls 104a-104f that include doors that would be apparent to one of skill in the art in possession of the present disclosure, and thus systems including those containers will fall within the scope of the present disclosure as well.

In various embodiments, the container locking system 100 may include a container locking device 116. The container locking device 116 may include a container chassis coupling device 118 that is configured to couple the container locking device 116 to container chassis 104 and/or one or more of the locking bars 112a-112d. The container locking device 116 may include a node device 120 that is coupled to the container chassis coupling device 118. In various embodiments, the container locking device 116 may include a seal 122 that is coupled to the node device 120 and at least one of the container chassis coupling device 118, the container chassis 102, or at least one of the locking bars 112a-112d. The details of the container locking device 116 are described in further detail below.

In various embodiments, the node device 120 may include a processing system, a memory system, a short-range communication interface, and in some embodiments, a long-range communication interface and that is described as the container module in the U.S. Pat. No. 10,538,371 and that is described in U.S. patent application Ser. No. 16/451,879, filed on Jun. 25, 2019, entitled “Container Security System,” the node device described in U.S. patent application Ser. No. 17/021,140, attorney docket number 55700.7US01, filed on Sep. 15, 2020 entitled “Container Closure Node System,” and in U.S. Utility application Ser. No. 17/021,214 (attorney docket number 55700.8US01), filed Sep. 15, 2020, entitled “Container Valve Node System” the disclosures of which are incorporated by reference herein in their entirety. While a specific container locking device 116 is illustrated, one or skill in the art in possession of the present disclosure will recognize that other container locking device 116 may be provided that may benefit from the teachings of the present disclosure. While a specific container locking system 100 has been illustrated and described, one of skill in the art in possession of the present disclosure will recognize that the container locking system 100 of the present disclosure may include a variety of components and component configurations while remaining within the scope of the present disclosure as well.

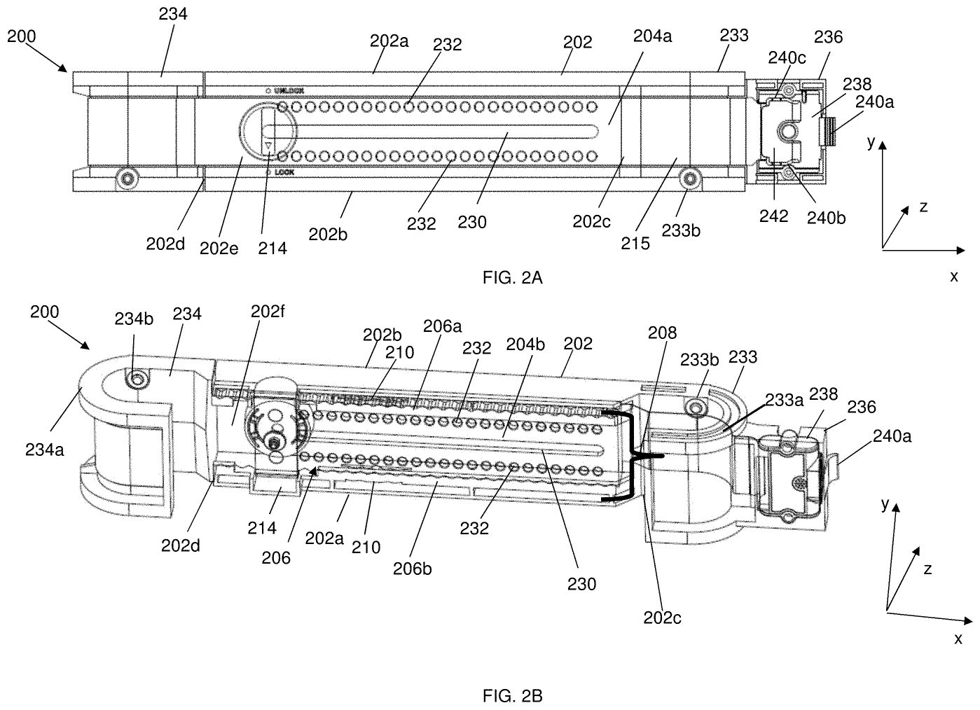

Referring now to FIG. 2, an embodiment of a container chassis coupling device 200 is illustrated that may provide the container chassis coupling device 118 included in the container locking device 116 of the container locking system 100 discussed above with reference to FIG. 1. The container chassis coupling device 200 may include a container chassis coupling device chassis 202 that includes a top side 202a, a bottom side 202b that is located opposite the container chassis coupling device chassis 202 from the top side 202a, and a pair of end sides 202c and 202d that are located opposite the container chassis coupling device chassis 202 from each other and that extend between the top side 202a and the bottom side 202b. The container chassis coupling device chassis 202 may include a front surface 202e that extends between the top side 202a, the bottom side 202b, and the end sides 202c and 202d, and a rear surface 202f that that is located opposite the container chassis coupling device chassis 202 from the front surface 202e and that extends between the top side 202a, the bottom side 202b, and the end sides 202c and 202d.

The container chassis coupling device chassis 202 of container chassis coupling device 200 may include one or more mounting brackets. For example, as illustrated in FIGS. 2A and 2B, the container chassis coupling device chassis 202 may include a first mounting bracket 204a and a second mounting bracket 204b. The first mounting bracket 204a and the second mounting bracket may be slidably coupled together via a slidable coupling 206. The slidable coupling 206 may be configured to permit movement of the first mounting bracket 204a relative to the second mounting bracket 204b along the x-axis (e.g., along the length of the container chassis coupling device 200) while restricting movement of the first mounting bracket 204a relative to the second mounting bracket 204b along the z-axis and the y-axis. For example, the slidable coupling 206 may include a first track element 206a and a second track element 206b that extend from the rear surface 202f of the first mounting bracket 204a. The first track element 206a and the second track element 206b may define a slot 208. The slot 208 may be defined such that the dimensions of the slot 208 may house the second mounting bracket 204b. As illustrated in FIG. 2B, the first track element 206a and the second track element 206b are illustrated as see-through to view other components described below and to see the second mounting bracket 204b within the slot.

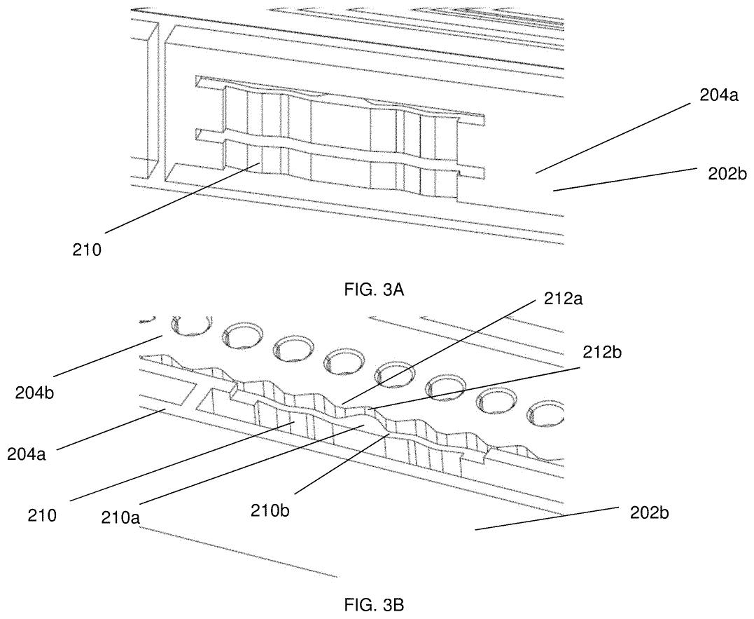

In various embodiments, the first track element 206a and the second track element 206b of the slidable coupling 206 may be include one or more retaining clips 210 that are configured to engage the second mounting bracket 204b. Referring to FIGS. 3A and 3B, the retaining clip 210 may include one or more teeth 210a that define spaces 210b. The one or more teeth 210a are configured to engage with at least one of a plurality of spaces 212b defined by a plurality of teeth 212a that extend from the top side 202a and/or the bottom side 202b of the second mounting bracket 204b. The one or more retaining clips and the plurality of teeth 212a on the second mounting bracket 204b may be used to restrict movement of the first mounting bracket 204a relative to the second mounting bracket 204b along the x-axis (e.g., along the length of the container chassis coupling device 200) when the one or more retaining clips 210 are engaged with the teeth 212a on the second mounting bracket 204b. In various embodiments, the front surface 202e may define a seal track 215 in which the seal 122 of FIG. 1 may be positioned, as discussed further below. As such, the retaining clips 210 may allow for potential changes in the distance between the bars and any variation. The retaining clips 210 may also allow the container chassis coupling device 200 to be applied to alternative types of containers such as flatbed boxes, pickup trucks, and/or other containers.

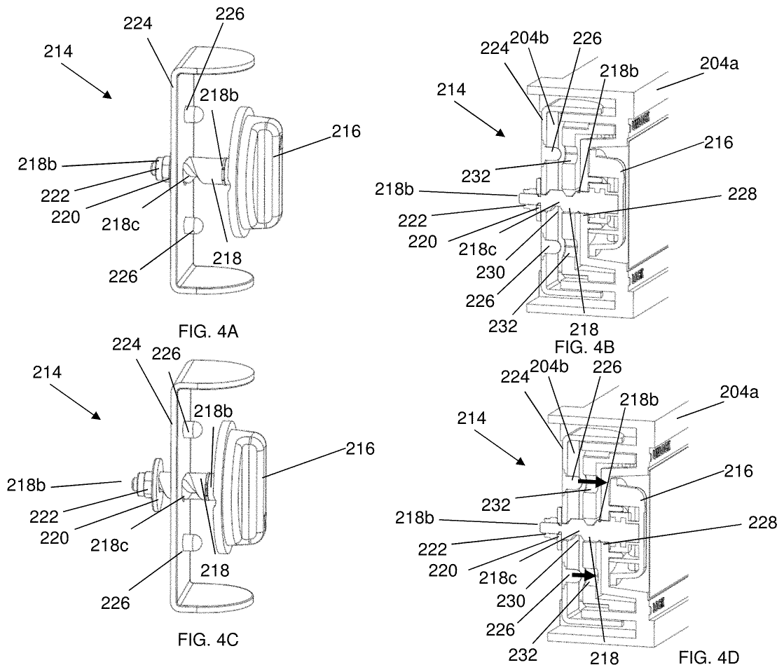

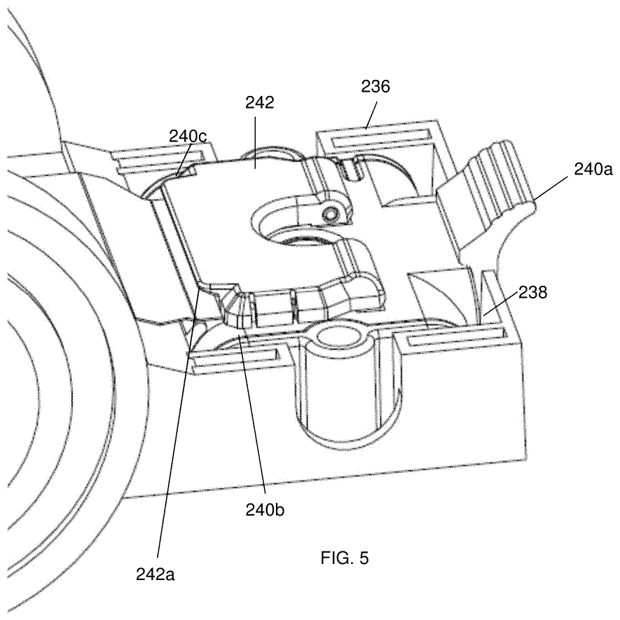

Referring again to FIGS. 2A and 2B, in various embodiments, the container chassis coupling device 200 may include a bracket lock device 214 that may be configured to restrict movement of the first mounting bracket 204a relative to the second mounting bracket 204b along the x-axis (e.g., along the length of the container chassis coupling device 200) when the bracket lock device 214 is in a lock orientation. The bracket lock device 214 may be configured to permit movement of the first mounting bracket 204a relative to the second mounting bracket 204b along the x-axis when the bracket lock device 214 is in an unlock orientation. For example and referring to FIGS. 4A, 4B, 4C, and 4D, the bracket lock device 214 may include a knob 216 that is coupled to a shaft 218 at a first shaft end 218a that is configured to rotate the shaft 218 about a longitudinal axis of the shaft 218. A second end 218b of the shaft 218 may be coupled to a washer 220 and nut 222. The washer 220 and nut 222 may be provided to prevent a stop plate 224 that is threaded onto a thread 218c of the shaft 218 from de-threading the shaft 218. The stop plate 224 may include one or more stoppers 226 that extend from the stop plate 224 in the direction that the front surface 202e is facing.

The shaft 218 may be provided through a shaft aperture 228 that is defined by the first mounting bracket 204a and a shaft slot 230 defined by the second mounting bracket 204b. The knob 216 may be located on the front surface 202e of the first mounting bracket 204a and the stop plate 224 may be located on the rear surface 202f of the second mounting bracket 204b. The second mounting bracket 204b may also define a plurality of stopper apertures 232 that run along the length of the second mounting bracket 204b. The bracket lock device 214 may be configured such that when the knob 216 is in an unlock orientation, the shaft 218 extends the stop plate 224 such that the stop plate 224 does not engage the second mounting bracket 204b and/or the one or more stoppers 226 do not engage the stopper apertures 232, as illustrated in FIGS. 4A and 4B. As such, movement of the first mounting bracket 204a relative to the second mounting bracket 204b along the x-axis (e.g., along the length of the container chassis coupling device 200) when the bracket lock device 214 is in the unlock orientation is permitted.

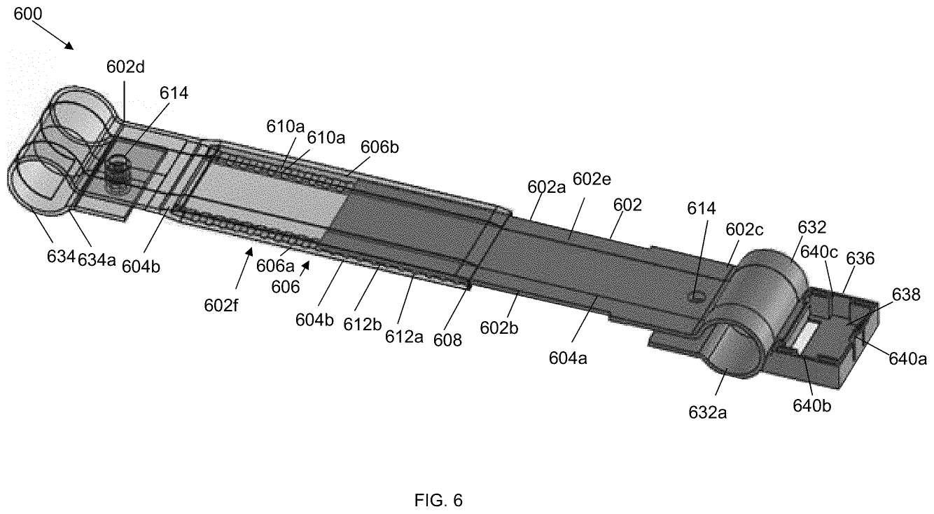

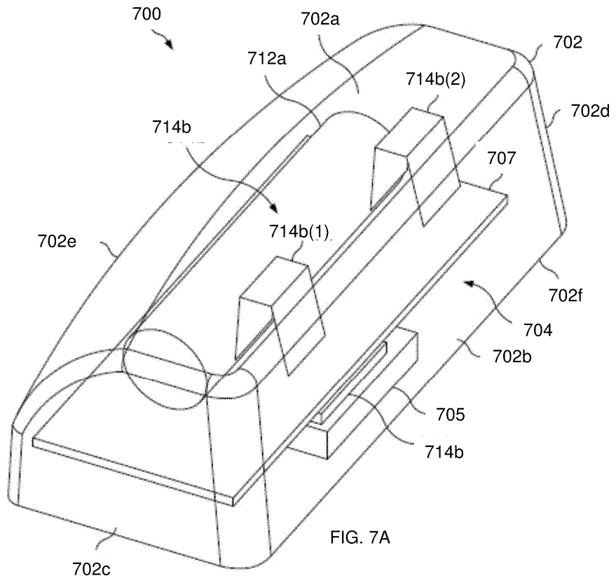

Alternatively, if the bracket lock device 214 is in a lock orientation, the shaft 218 compresses the stop plate 224 such that the stop plate 224 engages the second mounting bracket 204b and/or the one or more stoppers 226 engage the stopper apertures 232, as illustrated in FIGS. 4C and 4D. As such, movement of the first mounting bracket 204a relative to the second mounting bracket 204b along the x-axis (e.g., along the length of the container chassis coupling device 200) when the bracket lock device 214 is in the lock orientation is restricted. While a specific bracket lock device 214 is illustrated, one of skill in the art in possession of the present disclosure will recognize that other bracket lock devices (e.g., the bracket lock device 614 of FIG. 6) that restrict and/or permit movement of the first mounting bracket 204a relative to the second mounting bracket 204b along the x-axis are contemplated and fall under the scope of the present disclosure.

The first mounting bracket 204a may be coupled to a first locking bar securing element 233. The first locking bar securing element 233 may be configured to engage the first mounting bracket 204a with a locking bar on the container 102 of FIGS. 1A and 1B. In various embodiments, the first locking bar securing element 233 may extend from the end side 202c of the first mounting bracket 204a. The first locking bar securing element 233 may include a hook-shaped member 233a. However, other bar engagement members (e.g., a C-shaped member, a U-shaped member, a buckle bracket, etc.) may be contemplated. The hook-shaped member 233a may extend toward the rear surface 202f of the container chassis coupling device 200. The first locking bar securing element 233 may also include a bar stopper device 233b. The bar stopper device 233b may include a screw that may frictionally engage a locking bar when the bar stopper device 233b engages the locking bar and may be configured to restrict movement of the container chassis coupling device 200 along the longitudinal axis (e.g., vertical axis) of the locking bar.

Similarly, the second mounting bracket 204b may be coupled to a second locking bar securing element 234. The second locking bar securing element 234 may be configured to engage the second mounting bracket 204b with a locking bar on the container 102 of FIGS. 1A and 1B. In various embodiments, the second locking bar securing element 234 may extend from the end side 202d of the second mounting bracket 204b. The second locking bar securing element 234 may include a hook-shaped member 234a. However, other bar engagement members (e.g., a C-shaped member, a U-shaped member, a buckle bracket, etc.) may be contemplated. The hook-shaped member 234a may extend toward the rear surface 202f of the container chassis coupling device 200. The second locking bar securing element 234 may also include a bar stopper device 234b. The bar stopper device 234b may include a screw that may frictionally engage a locking bar when the bar stopper device 234b engages the locking bar and may be configured to restrict movement of the container chassis coupling device 200 along the longitudinal axis (e.g., vertical axis) of the locking bar.

In various embodiments and referring to FIGS. 2A, 2B, 5, the container chassis coupling device 200 may include a node mounting device 236 that is coupled to the first mounting bracket 204a or the second mounting bracket 204b. The node mounting device 236 may define a node housing 238 in which a node device may be housed. The node mounting device 236 may include one or more node retaining clips such as a quick-release retaining clip 240a, a node retaining clip 240b, and a node retaining clip 240c. The node retaining clips 240a-240c may be configured to secure a node device within the node housing 238. The one or more node retaining clips 240a-240c may be configured to be released by a user to disengage the node device from the housing. When installing the node device, the one or more node retaining clips 240a-240c may retract with pressure exerted by the node device one the one or more node retaining clips 240a-240c and then return to position when the node device is within the node housing 238 such that they engage the node device. While illustrated as being coupled to a node device, the node mounting device 236 may include a node mounting device cover 242 that is configured to cover the node device in the node housing 238. The node mounting device cover 242, when in a closed position may define a seal aperture 242a that provides an aperture through which the seal 122 of FIG. 1B may access the node housing 238 and the node device housed therein. The node mounting device cover 242 may be rotatably coupled to the node mounting device 236 or the node mounting device cover 242 may be frictionally coupled with the node mounting device 236.

Referring now to FIG. 6, a container chassis coupling device 600 is illustrated that may be an alternative embodiment of the container chassis coupling device 200 of FIGS. 2A-2C. As illustrated in FIG. 6, the container chassis coupling device 600 may provide the container chassis coupling device 118 included in the container locking device 116 of the container locking system 100 discussed above with reference to FIG. 1. The container chassis coupling device 600 may include a container chassis coupling device chassis 602 that includes a top side 602a, a bottom side 602b that is located opposite the container chassis coupling device chassis 602 from the top side 602a, and a pair of end sides 602c and 602d that are located opposite the container chassis coupling device chassis 602 from each other and that extend between the top side 602a and the bottom side 602b. The container chassis coupling device chassis 602 may include a front surface 602e that extends between the top side 602a, the bottom side 602b, and the end sides 602c and 602d, and a rear surface 602f that that is located opposite the container chassis coupling device chassis 602 from the front surface 602e and that extends between the top side 602a, the bottom side 602b, and the end sides 602c and 602d.

The container chassis coupling device chassis 602 of container chassis coupling device 600 may include one or more mounting brackets. For example, as illustrated in FIG. 6, the container chassis coupling device chassis 602 may include a first mounting bracket 604a and a second mounting bracket 604b. The first mounting bracket 604a and the second mounting bracket 604b may be slidably coupled together via a slidable coupling 606. The slidable coupling 606 may be configured to permit movement of the first mounting bracket 604a relative to the second mounting bracket 604b along the x-axis (e.g., along the length of the container chassis coupling device 600) while restricting movement of the first mounting bracket 604a relative to the second mounting bracket 604b along the z-axis and the y-axis. For example, the slidable coupling 606 may include a first track element 606a and a second track element 606b that extend from the rear surface 602f of the second mounting bracket 604b. The first track element 606a and the second track element 606b may define a slot 608. The slot 608 may be defined such that the dimensions of the slot 608 may house the first mounting bracket 604a.

In various embodiments, the first track element 606a and the second track element 606b of the slidable coupling 606 may be include a plurality of teeth 610a that define spaces 610b. The one or more teeth 610a are configured to engage with at least one of a plurality of spaces 612b defined by a plurality of teeth 612a that extend from the rear surface 602f of the first mounting bracket 604a. The teeth 610a on the second mounting bracket 604b and the teeth 612a on the first mounting bracket 604a may be used to restrict movement of the first mounting bracket 604a relative to the second mounting bracket 604b along the x-axis (e.g., along the length of the container chassis coupling device 600) when the teeth 610a and the teeth 612a are engaged with each other. As such, the teeth 610a and 612a may provide a ratcheted track such that the slidable coupling 606 only permits movement of the first mounting bracket 604a relative to the second mounting bracket 604b along the x-axis in one-direction and the second-direction is only permitted when the 610a and 612a are released. For example, the container chassis coupling device may only decrease in length and can only increase in length if the teeth 610a and the teeth 612a disengage with each other.

The first mounting bracket 604a may be coupled to a first locking bar securing element 632. The first locking bar securing element 632 may be configured to engage the first mounting bracket 604a with a locking bar on the container 102 of FIG. 1. In various embodiments, the first locking bar securing element 632 may extend from the end side 602c of the first mounting bracket 604a. The first locking bar securing element 632 may include a buckle member 632a. However, other bar engagement members (e.g., a C-shaped member, a U-shaped member, a hook member (e.g., hook member 232a of FIGS. 2A and 2B, etc.) may be contemplated. The buckle member 632a may extend from the rear surface 602f of the container chassis coupling device 600 and the front surface 602e of the container chassis coupling device 600. Such an arrangement may provide a lower profile for the container chassis coupling device 600 as the first mounting bracket 604a and the second mounting bracket 604b may not extend past the locking bars 112a-112d on the container 102 of FIG. 1. While not illustrated, the first locking bar securing element 632 may also include the bar stopper device 232b of FIG. 2.

Similarly, the second mounting bracket 604b may be coupled to a second locking bar securing element 634. The second locking bar securing element 634 may be configured to engage the second mounting bracket 604b with a locking bar on the container 102 of FIGS. 1A and 1B. In various embodiments, the second locking bar securing element 634 may extend from the end side 602d of the second mounting bracket 604b. The second locking bar securing element 634 may include a buckle bracket 634a. However, other bar engagement members (e.g., a C-shaped member, a U-shaped member, a hook member (e.g., the hook-shaped member 234a of FIGS. 2A and 2B), etc.) may be contemplated. The buckle bracket 634a may extend from the rear surface 602f of the container chassis coupling device 600 and the front surface 602e of the container chassis coupling device 600. Such an arrangement may provide a lower profile for the container chassis coupling device 600 as the first mounting bracket 604a and the second mounting bracket 604b may not extend past the locking bars 112a-112d on the container 102 of FIG. 1. While not illustrated, the first locking bar securing element 632 may also include the bar stopper device 234b of FIG. 2.

In various embodiments, the container chassis coupling device 600 may include a bracket lock device 614 that may be configured to restrict movement of the first mounting bracket 604a relative to the second mounting bracket 604b along the x-axis (e.g., along the length of the container chassis coupling device 200) when the bracket lock device 614 is in a lock orientation. The bracket lock device 614 may be configured to permit movement of the first mounting bracket 604a relative to the second mounting bracket 604b along the x-axis when the bracket lock device 614 is in an unlock orientation. For example, the bracket lock device 614 may include one or more fasteners that couple the ends of the buckle bracket 634a together and the ends of the buckle bracket 634b together such that the buckle brackets 634a and 634b cannot be removed from their respective locking bars, which prevents the movement of the first mounting bracket 604a relative to the second mounting bracket 604b along the x-axis.

In various embodiments, the container chassis coupling device 600 may include a node mounting device 636 that is coupled to the first mounting bracket 604a or the second mounting bracket 604b. The node mounting device 636 may define a node housing 638 in which a node device may be housed. The node mounting device 636 may include one or more node retaining clips such as a quick-release retaining clip 640a, a node retaining clip 640b, and a node retaining clip 640c. The node retaining clips 640a-640c may be configured to secure a node device within the node housing 638. The one or more node retaining clips 640a-640c may be configured to be released by a user to disengage the node device from the housing. While specific container chassis coupling devices 200 and 600 are illustrated, one of skill in the art in possession of the present disclosure will recognize that the container chassis coupling device 200 and 600 of the present disclosure may include a variety of components and component configurations while remaining within the scope of the present disclosure as well.

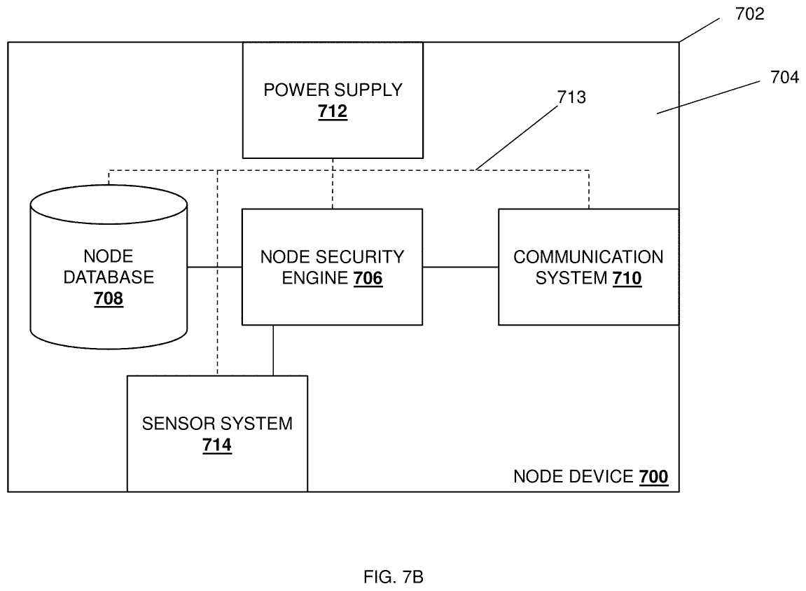

Referring now to FIGS. 7A and 7B, an embodiment of a node device 700 is illustrated that may provide the node device 120 included in the container locking device 116 discussed above with reference to FIG. 1. The node device 700 includes a node chassis 702 that includes a top wall 702a, a bottom wall 702b that is located opposite the node chassis 702 from the top wall 702a, and a pair of side walls 702c and 702d that are located opposite the node chassis 702 from each other and that extend between the top wall 702a and the bottom wall 704b. The node chassis 702 may include a front wall 702e that extends between the top wall 702a, the bottom wall 702b, and the side walls 702c and 702d, and a rear wall 702f that that is located opposite the node chassis 702 from the front wall 702e and that extends between the top wall 702a, the bottom wall 702b, and the side walls 702c and 702d. A node volume 704 is defined by the node chassis 702 by the top wall 702a, the bottom wall 702b, the side walls 702c and 702d, the front wall 702e, and the rear wall 702f. In the illustrated embodiment, the top wall 702a, the bottom wall 702b, the side walls 702c and 702d, the front wall 702e, and/or the rear wall 702f may define a component access aperture (not illustrated) that may be used to access any node components housed in the node volume 704.

In various embodiments, the node chassis 702 may include a node securing element 705 that may be configured to engage the node mounting device 236 on the container chassis coupling device 200 of FIG. 2 to couple the container chassis coupling device 200 to the node device 700. For example, the node securing element 705 may engage the node retaining clips 240a, 240b and/or 240c. While a particular node securing element 705 is illustrated, one of skill in the art will recognize that any other node securing elements 705 may be included on or defined by the node chassis 702 (e.g., notches, recesses, etc.) that may engage the node retaining clips 240a, 240b, and/or 240c.

Furthermore, while illustrated and discussed as a node device 700, one of skill in the art in possession of the present disclosure will recognize that the functionality of the node device 700 discussed below may be provided by other devices that are configured to operate similarly as discussed below. In the illustrated embodiment, the node device 700 includes the node chassis 702 that houses the components of the node device 700 in the node volume 704, only some of which are illustrated below. For example, the node chassis 702 may house a processing system (not illustrated but may be provided by a processor) and a memory system (not illustrated but may be provided by system memory (e.g., random access memory (RAM) devices such as dynamic RAM (DRAM), synchronous DRAM (SDRAM), solid state memory devices, and/or a variety of other memory devices known in the art) that is coupled to the processing system and that includes instructions that, when executed by the processing system, cause the processing system to provide a node security engine 706 that is configured to perform the functionality of the node security engines and/or node devices discussed below. The processing system and the memory system may be provided on a circuit board 707. While a processing system and a memory system are discussed as providing the node security engine 706, the node security engine 706 may be provided by application specific integrated circuits (ASICs), field-programmable gate arrays (FPGAs), complex programmable logic devices (CPLDs) and/or any other hardware circuit that may be configured to cause a communication interface, discussed below, to provide a notification in response to a security sensor signal being generated by a security sensor.

The node chassis 702 may also house a storage system (not illustrated, but which may include mass storage devices that may include hard discs, optical disks, magneto-optical discs, solid-state storage devices, and/or a variety other mass storage devices known in the art.) that is coupled to the node security engine 706 (e.g., via a coupling between the storage system and the processing system) and that includes a node database 708 that is configured to store any of the information utilized by the node security engine 706 discussed below. The node chassis 702 may also house a communication system 710 that is coupled to the node security engine 706 (e.g., via a coupling between the communication system 710 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. In a particular embodiment, the communication system 710 may include a communication interface (e.g., a relatively short-range and/or relatively low-power transceiver(s)) that is configured to provide direct communication with other devices (e.g., a corresponding communication interface in the container 102 of FIG. 1). For example, the communication interface may be configured to operate according to wireless protocols such as Bluetooth®, Bluetooth® Low Energy (BLE), near field communication (NFC), infrared data association (IrDA), ANT®, Zigbee®, Z-Wave®, IEEE 802.11 protocols (Wi-Fi), and/or any other wireless communication protocols that allow for the direct device communication described herein. In some embodiments, the communication system 710 may be included on the circuit board 707.

The node chassis 702 may also house a power supply system 712 that may include and/or be configured to couple to a battery 712a. For example, the power supply system 712 may include an integrated rechargeable battery that may be recharged in the node chassis 702 using methods known in the art, and/or may include other power sources that would be apparent to one of skill in the art in possession of the present disclosure. For example, the power supply system 712 and node chassis 702 may be configured to accept a replaceable, non-rechargeable/rechargeable battery while remaining within the scope of the present disclosure as well. The power supply system 712 may be coupled to the node security engine 706, the node database 708, the communication system 710 and/or a sensor system 714 via a power bus 713.

The node chassis 702 may also house and/or provide the sensor system 714. The sensor system 714 may include one or more security sensors that detect a security event. For sensor system 714 may include a node device movement sensor 714a (e.g., a Hall effect sensor or other motion sensor) that is provided adjacent the bottom wall 702b, included in the node securing element 705 and/or housed elsewhere in node chassis 702 such that the node device movement sensor 714a can detect when the node device 700 has moved relative to the container 102. For example, the node device movement sensor 714a may include a Hall effect sensor that can detect a magnetic field provided by a magnet coupled to and/or embedded in the front wall 104e of the container chassis 104 of FIG. 1 when in a first position range and provide a first signal when in that first position range. The Hall effect sensor may also detect the lack of presence of a magnetic field or a weak magnetic field when outside of the first position range and generate a second signal (e.g., a security signal indicating that the node device 700 has moved relative to the magnet indicating that that the container locking device 116 and/or the node device 120 of FIG. 1 has been moved such that the contents of the container 102 have been possibly accessed). While a Hall effect sensor is described as detecting movement of the container locking device 116 and/or the node device 120 relative to the container 102, one of skill in the art will recognize that the node device movement sensor 714a may include other sensors that may detect movement of the container locking device 116 and/or the node device 120 relative to the container 102.

In another example, the sensor system 714 may include other security sensors such as a seal presence sensor 714b. The seal presence sensor 714b may include a first electrical contact 714b(1) and a second electrical contact 714b(2) on the top wall 702a and/or other wall of the node chassis 702 that forms a closed circuit when the seal 122 of FIG. 1 is coupled to the node device 700 and that provides a first signal to the node security engine 706. The seal presence sensor 714b may provide a second signal (e.g., a security signal) to the node security engine 706 when the seal 122 of FIG. 1 is decoupled from the first electrical contact 714b(1) and/or the second electrical contact 714b(2) indicating that the seal 122 has been removed from the container closure 110. However, in other embodiments a seal tamper event may be detected by the node security engine 706 via the first electrical contacts 714b(1) and the second electrical contacts 714b(2). While specific security sensors 714a and 714b have been described as being included in the sensor system 714, one of skill in the art in possession of the present disclosure will recognize that other security sensors or information sensors may be included in the sensor system 714. For example, the sensor system 714 may include, for example, a load sensors, a temperature sensor, a humidity sensor, a chemical agent sensor, a positioning sensor, an orientation sensor, a pressure sensor, a movement sensor (e.g., an accelerometer), a shock sensor, and/or any other sensors that would be apparent to one of skill in the art in possession of the present disclosure. While a specific node device 700 has been illustrated, one of skill in the art in possession of the present disclosure will recognize that node devices (or other devices operating according to the teachings of the present disclosure in a manner similar to that described below for the node device 700) may include a variety of components and/or component configurations for providing the functionality discussed below, while remaining within the scope of the present disclosure as well.

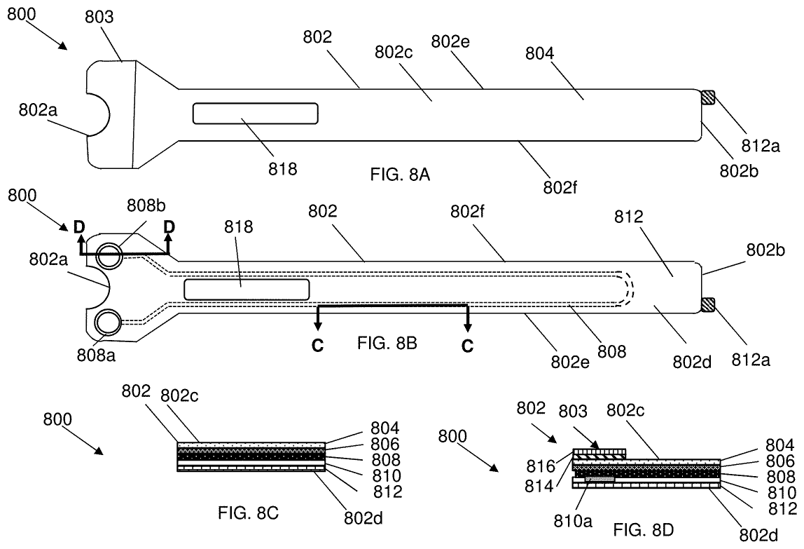

Referring now to FIGS. 8A, 8B, 8C, and 8D an embodiment of a seal 800 is illustrated that may provide the seal 122 included in the container locking device 116 discussed above with reference to FIG. 1. The seal 800 may include a conforming member 802. The conforming member 802 may include a first end 802a and a second end 802b that is opposite the conforming member 802 from the first end 802a. The conforming member 802 may also include a first surface 802c and a second surface 802d that is opposite the conforming member 802 from the first surface 802c and the first surface 802c and the second surface 802d extend between the first end 802a and the second end 802b. The conforming member 802 may also include a first edge 802e that extends between the first surface 802c, the second surface 802d, the first end 802a, and the second end 802b, and a second edge 802f that is opposite the conforming member 802 from the first edge 802e and that extends between the first surface 802c, the second surface 802d, the first end 802a, and the second end 802b. The conforming member 802 may be configured to the dimensions of the seal track 215 defined on the front surface 202e of the container chassis coupling device chassis 202. In some embodiments, the seal 800 may be rigid such that the seal 800 is manufactured to fit the dimensions of the seal track 215 defined on the front surface 202e of the container chassis coupling device chassis 202 and the node mounting device 236 so that an electrical contact on the seal 800, discussed below, may be electrically coupled to the node device 700.

However, in other embodiments, the seal 800 may be malleable such that the seal 800 may be applied to the seal track 215 defined on the front surface 202e of the container chassis coupling device chassis 202 or on other surfaces of the container chassis coupling device chassis 202, a container chassis coupling device chassis 202 that does not include a seal track 215, another coupling device that couples a node to a container closure, and/or other surfaces of one or more structures/components that would be apparent to one of skill in the art in possession of the present disclosure. As such, the seal 800 may be configured as a tape strip or a breakaway tape strip, as discussed herein. As illustrated in FIGS. 8A-8D conforming member 802 may be provided by a tape stack (illustrated in FIG. 8C as a cross-sectional view along the plane C-C) having a plurality of different layers. For example, in the illustrated embodiment of FIG. 8C, the tape stack includes an UltraViolet (UV) resist layer 804, a destructible body layer 806 that is adjacent the UV resist layer 804, a conductive layer 808 that is adjacent the destructible body layer 806 and opposite the destructible body layer 806 from the UV resist layer 804, an adhesive layer 810 that is adjacent the conductive layer 808 and opposite the conductive layer 808 from the destructible body layer 806, and an adhesive liner layer 812 that is adjacent the adhesive layer 810 and opposite the adhesive layer 810 from the conductive layer 808.

In FIG. 8D, the conforming member 802 may be provided by a node device connection area 803 (illustrated in FIG. 8D as a cross-sectional view along the plane D-D). The node device connection area 803 may include the tape stack of FIG. 8C that includes the UV resist layer 804, the destructible body layer 806 that is adjacent the UV resist layer 804, the conductive layer 808 that is adjacent the destructible body layer 806 and opposite the destructible body layer 806 from the UV resist layer 804, the adhesive layer 810 that is adjacent the conductive layer 808 and opposite the conductive layer 808 from the destructible body layer 806, and an adhesive liner layer 812 that is adjacent the adhesive layer 810 and opposite the adhesive layer 810 from the conductive layer 808. The node device connection area 803 may also include a conductive adhesive portion 810a included in the adhesive layer 810. The node device connection area 803 may also include an adhesive layer 814 that is adjacent the UV resist layer 804 and opposite the UV resist layer 804 from the conductive layer 808, and may include a stiffener shim 816 that is adjacent the adhesive layer 814 and opposite the adhesive layer 814 from the UV resist layer 804. The thickness of the conforming member 802 may be 0.15-1 mm and in some embodiments may be approximately 0.435 mm at the node device connection area 803 and 0.285 mm at the cross-section in FIG. 8C. However, one of skill in the art in possession of the present disclosure will recognize that other thicknesses, shapes, lengths, and/or widths may be contemplated depending on the application of the seal 800.

In various embodiments, the tape stack includes the UV resist layer 804 that may provide UV protection to the other layers of the tape stack. The container locking device 116 on which the seal 800 is included may be on a ship or yard for extended periods of time where the seal 800 is exposed to direct sunlight and UV radiation during those periods of time. The UV radiation may degrade the materials included in the tape stack. As such, the UV resist layer 804 may include UV resist ink (e.g., PMS420C), and/or any other UV resistant material that would be apparent to one of skill in the art in possession of the present disclosure that will protect the tape stack form UV radiation. The UV resist layer 804 may have negligible thickness in the tape stack and may be less than a micron. However, in other embodiments, the UV resist layer 804 may be other thicknesses and may be more than a micron (e.g., 1-10 μm).

The tape stack may also include the destructible body layer 806 that is located adjacent the UV resist layer 804 and that may include material that easily stretches, tears, breaks, and/or otherwise separates from itself. For example, the destructible body layer 806 may include a material and dimensions (e.g., thickness) that provides a plastic deformation or fractures when a force is applied to the destructible body layer 806 that is equal to or less than a force that is necessary to overcome a bonding strength between the adhesive layer 810 and the front surface 202e of the container chassis coupling device 200 and/or a bonding strength between the adhesive layer 810 and the destructible body layer 806. However, the plastic deformation or fracture characteristics of the destructible body layer 806 should be strong enough such that plastic deformation or fracture does not occur to the destructible body layer 806 when overcoming a bonding strength between the adhesive layer 810 and the adhesive liner layer 812 so that user of the seal 800 may apply the seal 800 to its intended surface without jeopardizing the mechanical properties and the conductive layer 808. In other embodiments, the destructible body layer 806 may include a thickness and/or material that may provide an elastic deformation when the force is applied to the destructible body layer 806 that is at least less than a force that is necessary to overcome a bonding strength between the adhesive layer 810 and the front surface 202e of the container chassis coupling device 200 and/or a bonding strength between the adhesive layer 810 and the destructible body layer 806. The elastic deformation characteristic of the material should be such that when the adhesive bond between the adhesive layer 810 and the front surface 202e is undone, the destructible body layer 806 should have experienced a deformation (e.g., an elastic deformation, a plastic deformation, and/or any other deformation) and/or a fracture that causes the impedance of the conductive layer 808 to change that is detectable by the node device 700 to indicate a seal tamper event, as discussed in further detail below. Also, the material that provides the destructible body layer 806 may be an insulator with a high electrical resistance and provide insulation to the conductive layer 808.

In specific examples, the destructible body layer 806 may include a vinyl material such as A202. However, other materials that would be apparent to one of skill in the art that has the characteristics described above will fall under the scope of the present disclosure. The destructible body layer 806 may be of a thickness 0.05-0.2 mm. However, other thicknesses are contemplated depending on the application of the seal 800. The force to break the seal 800 is at least 10 N. However, other forces may be contemplated (e.g., 5 N, 1 N, etc.) depending on the application of the seal 800.

The tape stack may also include the conductive layer 808. The conductive layer 808 may include one or more conductors. For example, the conductive layer 808 may include one or more traces that are formed on or within the destructible body layer 806. As such, the conductive layer 808 may not extend the entire width and/or length of the conforming member 802 and in the illustrated embodiment, forms a loop that where each end of the conductive trace connects to a respective conductive contact 808a and 808b that are adjacent to each other and dimensioned to electrically connect with the first electrical contact 714b(1) and/or the second electrical contact 714b(2) on the node device 700. The conductive layer 808 may be made of a conductive material such as carbon, silver, and/or any other conductive material that would be apparent to one skill in the art in possession of the present disclosure and be of dimensions that causes conductive layer 808 to experience a deformation and/or fracture that similar to that of the destructible body layer 806 and/or a deformation and/or a facture that causes a change in an impedance, a conductivity, or otherwise a signal being provided on the conductive layer 808 that is detectible by the node device 700 and indicative of the seal 800 experiencing a seal tamper event. In specific examples, the conductive layer 808 may be 1-10 μm and the conductive layer 808 may have an initial resistance of 5-20 ohms. However, one of skill in the art in possession of the present disclosure will recognize that other thicknesses and resistances may be contemplated depending on the application of the seal 800.

The tape stack may also include an adhesive layer 810. In various embodiments, the adhesive layer 810 may provide an adhesive bond between the seal 800 and a surface (e.g., the front surface 202e of the container chassis coupling device chassis 202). The adhesive layer 810 may provide an adhesive bond that is sufficient enough such that gravity does not cause the adhesive bond to break. In other examples, the adhesive bond should further be greater than the force required to cause the desirable deformation of the destructible body layer 806 and/or the conductive layer 808. In various embodiments, the adhesive layer 810 may be a 3M® 300L SE adhesive, a 3M® 9471LSE adhesive, and/or any other adhesive that would be apparent to one of skill in the art in possession of the present disclosure. In some embodiments, the adhesive layer 810 may be masked to provide exposure of the conductive contacts 808a and 808b in the conductive layer 808. In other embodiments, the adhesive layer 810 may be provided by or may be a continuation of the destructible body layer 806. For example, the destructible body layer 806 may have a greater bonding strength or similar bonding strength with the material of the container chassis coupling device chassis 202 than the bonding strength holding together the material of destructible body layer 806 itself. In a specific example, the adhesive layer 810 may have a thickness of 0.01-0.1 mm. However, one of skill in the art in possession of the present disclosure will recognize that other thicknesses may be contemplated depending on the application of the seal 800.

The tape stack may also include an adhesive liner layer 812 that may include a liner that weakly adheres to the adhesive layer 810 and that is configured to protect the adhesive layer 810 prior to the use of the seal 800. For example, the adhesive liner layer 812 may include an adhesive liner layer tab 812a that extends from the conforming member 802 and that allows the user to remove the adhesive liner layer 812 from the adhesive layer 810 prior to adhering the seal to 800 to an intended surface via the adhesive layer 810. In a specific example, the adhesive liner layer 812 may be the adhesive liner for the 3M® 9471LSE adhesive and have a thickness between 0.5-0.15 mm. However, one of skill in the art in possession of the present disclosure will recognize that other thicknesses may be contemplated depending on the application of the seal 800.

The tape stack may also include a conductive adhesive layer 810a. In various embodiments, the conductive adhesive layer 810a may provide an adhesive bond between the conductive contacts 808a and 808b and the first electrical contact 714b(1) and the second electrical contact 714b(2), respectively. The conductive adhesive layer 810a may provide an adhesive bond that is sufficient enough such that gravity does not cause the adhesive bond to break (e.g., at least 10 N but may be more or less depending on the application of the seal 800). In other examples, the adhesive bond should further be greater than the force required to cause the desirable deformation of the destructible body layer 806 and/or the conductive layer 808. In various embodiments, the conductive adhesive layer 810a may be a conductive adhesive such as 3M® 9725 adhesive and/or any other conductive adhesive that would be apparent to one of skill in the art in possession of the present disclosure. In a specific example, the conductive adhesive layer 810a may have a thickness of 0.01-0.1 mm. However, one of skill in the art in possession of the present disclosure will recognize that other thicknesses may be contemplated depending on the application of the seal 800.

The tape stack may also include an adhesive layer 814. In various embodiments, the adhesive layer 814 may provide an adhesive bond between the seal 800 and the stiffener shim 816. The adhesive layer 814 may provide an adhesive bond that is sufficient enough such that gravity does not cause the adhesive bond to break. In various embodiments, the adhesive layer 814 may be a 3M® 300L SE adhesive, a 3M® 9471LSE adhesive, and/or any other adhesive that would be apparent to one of skill in the art in possession of the present disclosure. In a specific example, the adhesive layer 810 may have a thickness of 0.01-0.1 mm. However, one of skill in the art in possession of the present disclosure will recognize that other thicknesses may be contemplated depending on the application of the seal 800.

The tape stack may also include a stiffener shim 816 in the node device connection area 803. The stiffener shim 816 may provide support for the seal 800 to avoid buckling and twisting while applying the seal to a surface. The stiffener shim 816 may include any ridged material (e.g., polyethylene terephthalate (PET), polyethylene, and/or any other material that would provide ridged support to the seal 800 that would be apparent to one of skill in the art in possession of the present disclosure). While the stiffener shim 816 is located adjacent the conductive contacts 808a and 808b, the stiffener shim 816 or one or more other stiffener shims 816 may be formed along the length of the conforming member 802. In a specific example, the conductive adhesive layer 810a may have a thickness of 0.05-0.15 mm. However, one of skill in the art in possession of the present disclosure will recognize that other thicknesses may be contemplated depending on the application of the seal 800.

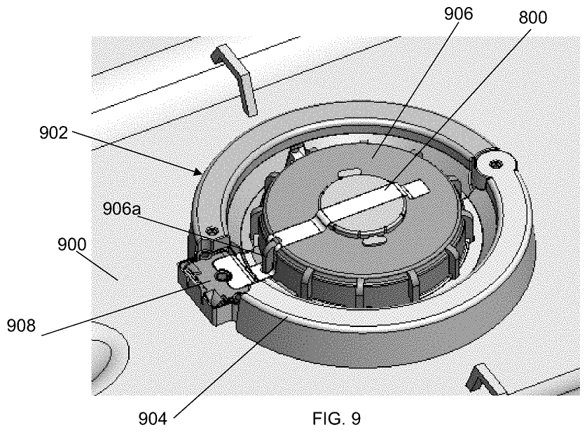

In various embodiments, the conforming member 802 may define one or more component apertures 818 that may be dimensioned to fit a conform the conforming member 802 around any irregularly shaped components. For example, and as illustrated in FIG. 9, a container system 900 that may include a container closure node system 902. The container closure node system 902 may include a closure chassis coupling device 904 that is configured to couple the container closure node system 902 to a container closure 906. The container closure node system 902 may include a node device 908 that is coupled to the closure chassis coupling device 904. In various embodiments, the container closure node system 902 may include the seal 800 that includes a component aperture 814 that configured to provide an opening through which a protrusion 906a extending from the container closure 906 can be access. As such, the seal 800 is coupled to the container closure 906 and at least the node device 908. The container system 900, the container closure node system 902, the closure chassis coupling device 904, the container closure 906, and the node device 908 may be the respective components described in U.S. patent application Ser. No. 16/451,879, filed on Jun. 25, 2019, entitled “Container Security System,” the node device described in U.S. patent application Ser. No. 17/021,140, attorney docket number 55700.7US01, filed on Sep. 15, 2020 entitled “Container Closure Node System,” which is incorporated by reference in its entirety. Similarly, the seal 800 disclosed herein may include the seal 128 and/or included any of the components or functionality of the seal 128 disclosed in U.S. patent application Ser. No. 16/451,879. For example, the seal 800 may include a communication interface (not illustrated) that is associated with a seal identifier. For example, the communication interface may include an RFID tag that may store a seal identifier that may be associated with the container 102, the container locking device 116, and/or the node device 120 and/or identifiers for the container 102, the container locking device 116, and/or the node device 120 of FIGS. 1A and 1B. In another example, the communication interface may include an NFC tag in the tape stack that may store the seal identifier. As such, one of skill in the art in possession of the present disclosure will recognize that the seal 800 described herein may be applied to other container configurations that includes a container security device and a node device that can detect seal tampering events as taught by the present disclosure.

While a specific combination of layers is illustrated and described in the tape stack of the conforming member 802, some of the layers may be optional (e.g., the UV resist layer 804, the adhesive layer 810, and/or the adhesive liner layer 812) and some of the layers may be positioned differently within the tape stack. For example, the conductive layer 808 may be located between the destructible body layer 806 and the UV resist layer 804. In other embodiments, the conductive layer 808 may be located within the destructible body layer 806 such that the conductive layer 808 is encapsulated by the destructible body layer 806 (e.g., between sublayers of the destructible body layer 806. As such, while a specific seal 800 has been illustrated, one of skill in the art in possession of the present disclosure will recognize that the tape stack of the conforming member 802 may be shaped, stacked, configured with fewer or more layers, and/or other configurations while still falling under the scope of the present disclosure. Furthermore, while a specific seal 800 has been illustrated, one of skill in the art in possession of the present disclosure will recognize that seals (or other devices operating according to the teachings of the present disclosure in a manner similar to that described below for the seal 800) may include a variety of components and/or component configurations for providing the functionality discussed below, while remaining within the scope of the present disclosure as well.

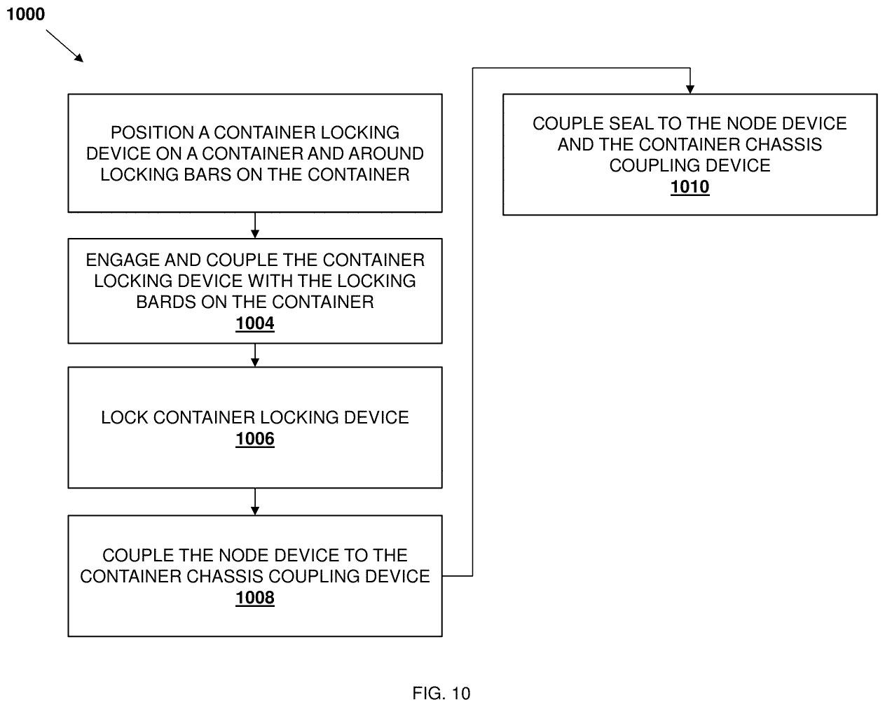

Referring now to FIG. 10, a method 1000 for coupling a container locking device to a container is illustrated. As discussed above, the systems and methods of the present disclosure provide a container locking device that is relatively easy to add and remove from locking bars that secure container doors of a container. The container locking device also maintains a low profile such that the container locking device does not interfere with conventional stacking and storage of containers. The container locking device may provide a security node for the container and the container locking device that can detect and report security events (e.g., when the container locking device has been removed and attached, when a seal has been tampered with, changes in temperature, etc.) during a container lifecycle.

The method 1000 begins at block 1002 where a container locking device is positioned on a container and around locking bars on the container. In an embodiment, at block 1002 and with reference to FIGS. 1A, 1B, 2A and 2B, the container locking device 116 may be positioned on the container 102 (e.g., the front wall 104e) and engaged with the locking bar 112b on the door 110a and the locking bar 112c on the door 110b. In the illustrated embodiment, the doors 110a and 110b may be in closed position and the locking bars 112b and 112c may be in a locked position to prevent the doors 110a and 110b from transitioning to an open position. The mounting brackets 204a and 204b may be extended to span the distance between the locking bars 112c and 112b, respectively such that the locking bar securing elements 233 and 234 may positioned around the locking bars 112c and 112b, respectively, and be in an open position. While in the open position, the container locking device 116 may be positioned on the container 102 and around the locking bars 112b and 112c. One of skill in the art will recognize that the container locking device 116 may be positioned around other locking bars (e.g., any combination of 112a, 112b, 112c, and/or 112d). As such, additional locking bar securing elements may be contemplated.

The method 1000 then proceeds to block 1004 where the container locking device is engaged and coupled with the locking bars on the container. In an embodiment, at block 1004 and with reference to FIGS. 1A, 1B, 2A and 2B, the locking bar securing elements 234 and 233 may be engaged and coupled to the locking bars 112b and 112c, respectively. The mounting brackets 204a and 204b may be contracted via the slidable coupling 206. The bracket lock device 214 may be in an unlock orientation to permit the slidable movement of the mounting brackets 204a and 204b in relation to each other. The container chassis coupling device 200 may be in the closed orientation when the hook-shaped member 234a is engaged with the locking bar 112b and the hook-shaped member 233a is engaged with the locking bar 112c.

The method 1000 may then proceed to block 1006 where the container locking device is locked. In an embodiment, at block 1006 and with reference to FIGS. 1A, 1B, 2A and 2B, the container locking device 116, when engaged and coupled with the locking bars 112b and 112c on the container 102, may be locked. As discussed above, the retaining clips 210 may retain the position of the container locking device 116 in the closed orientation. In other embodiments, the bracket lock device 214 may be positioned to the locked orientation such that the stoppers 226 engage the stopper apertures 232 defined by the second mounting bracket 204b by turning the knob 216. The container locking device 116 may not be able to be removed unless the bracket lock device 214 is positioned to an open orientation, and/or the retaining clips 210 are released.

The method 1000 may then proceed to block 1008 where the node device is coupled to the container chassis coupling device. In an embodiment, at block 1008 and with reference to FIGS. 1A, 1B, 2A and 2B, the node device 120 may be coupled to the container chassis coupling device 118/200. In an embodiment, the node device 120 may be coupled to the container chassis coupling device 118/200 prior to the container chassis coupling device 118/200 being coupled to the locking bars 112b and 112c. However, in other embodiments, the node device 120 may be coupled to the container chassis coupling device 200 during or after the container chassis coupling device 200 being coupled to the locking bars 112b and 112c. For example, the retaining clips 210 may engage the node chassis 702 of the node device 120. The node device 120 may be positioned over a magnet that is coupled to the container 102 such that the node device movement sensor 714a is aligned with the magnet.

The method 1000 may then proceed to block 1010 where a seal is coupled to the node device and the container chassis coupling device. In an embodiment, at block 1010 and with reference to FIGS. 1A, 1B, 2A and 2B, the seal 122 may be coupled to the container chassis coupling device 118 and the node device 120. The conforming member 802 of the seal 122 may be adhesively secured to the container chassis coupling device 118. The conductive contacts 808a and 808b may be coupled with the seal presence sensor 714b such that the conductive contacts 808a and 808b are in electrical contact with the first electrical contact 714b(1) and the second electrical contact 714b(2), respectively. In the illustrated embodiment, the seal 122 may positioned over the bracket lock device 214, the first mounting bracket 204a, and the second mounting bracket 204b such that the seal 122 has to be removed to remove the container chassis coupling device 118 from the locking bars 112b and 112c. As such, the seal 122 may be positioned on other components or combination of components included in the container locking device 116 such that the seal 122 has to be removed or tampered with resulting in a change in the impedance and/or signal of the conductive layer 808.

In various embodiments of method 1000, after the container locking device 116 is assembled and coupled to the locking bars 112b and 112c, a user may decouple the container locking device 116 from the locking bars 112b and 112c. For example, the user may remove the seal 122, which will cause the seal presences sensor 714b to generate a security signal, discussed below. The user may also detach the container chassis coupling device 118/200 by, for example, turning the knob 216 that is included on the bracket locking device 214 that disengages the stoppers 226 from the stopper apertures 232 included on the second mounting bracket 204b and/or a retaining clip release mechanism that releases the slidable coupling 206 to cause the container chassis coupling device 200 to be positioned in the open orientation such that the container chassis coupling device 118/200 may be removed by the locking bars 112b and 112c. The node device movement sensor 714a may generate a security signal when the container chassis coupling device 200 transitions to the open orientation as the node device 120 may move in relation to the container 102 and embedded magnet. In other examples, the node device 120 may be released from the node device mounting device 236 via actuation of the quick release clip 240aa and/or any of the node retaining clips 240b and/or 240c.

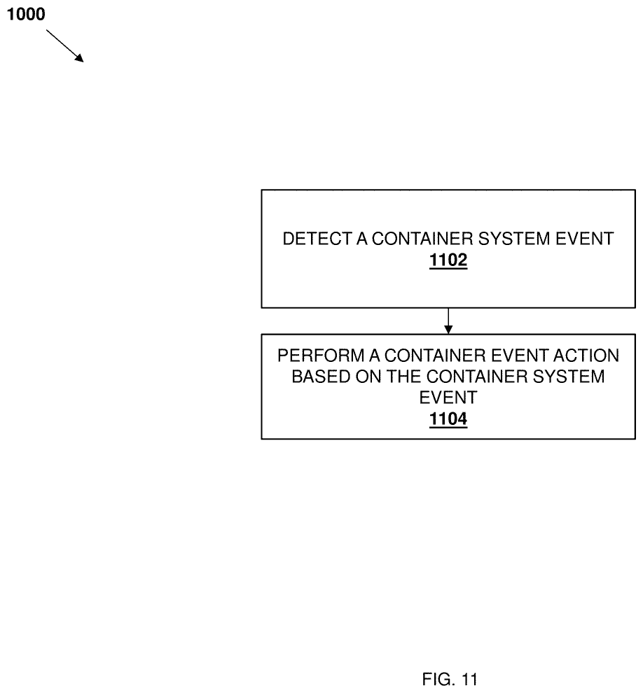

Referring now to FIG. 11, a method 1100 for providing container security is illustrated. The method 1100 begins at block 1102 where the node device detects a container system event. In an embodiment of block 1102, the node security engine 706 of the node device 122/700 may receive, via the sensor system 714 and/or the communication system 710, sensor signals and/or event notifications. The node security engine 706 may process the sensor signals to determine whether any conditions are satisfied. For example, the node security engine 706 may monitor sensor signals from the node device movement sensor 714a. The sensor signals may indicate to the node security engine 706 whether the node device 122/700 has moved relative to the container chassis 104. The node security engine 706 may monitor for signals indicating each orientation such as detecting or not detecting a magnetic field from the sensor system 714 at a magnetic field threshold. In another example, the node security engine 706 may detect a seal sensor signal provided by the seal presence sensor 714b when the seal 122/800 has been removed from the container locking device 116 and/or at the very least when the electrical contacts 814a and/or 814b are no longer in contact with the first electrical contact 714b(1) and/or the second electrical contact 714b(2) on the seal presence sensor 714b. However, as discussed above, the seal presence sensor 714b may detect changes in impedance, signal strength, conductivity, and/or other electrical property to the conductive layer 808 of the seal 122/800. As such, node security engine 706 may be configured to detect a change in an electrical characteristic of the conductive layer 808. For example, when the node security engine 706 first detects a presence of a seal 800, the node security engine 706 may wait for a steady impedance reading after the user puts the seal 800 into position as the user may be moving the seal while an impedance is being detected. The node security engine 706 may record the impedance detected and monitor for a tamper condition. For example, the node security engine 706 may monitor for a predetermined change in impedance. For example, if the impedance changes by 1%, 2%, 5%, 10%, 100% and/or by any other degree or value that would be apparent to one of skill in the art in possession of the present disclosure, then the tamper condition may exist. For example, when testing various seals having initial resistances between 10-14 ohms in various environmental conditions (e.g., high temperature, low temperature, rain simulation, salt mist simulation, infrared, ultraviolet, bending, etc.), the inventors of the present disclosure discovered that resistance could fluctuate up to 35%.

However, because the seal 800 may experience extreme temperature variations during shipment of the container 102, the predetermined change in impedance may be determined based on the on how the impedance of the material used in the conductive layer 808 changes with respect to temperature. Typically, in conductors, resistance increases when temperature increases. In other embodiments, to consider changes in impedance due to an environment, the node security engine 706 may monitor for a predetermined rate of change in impedance. A relatively quick change in impedance of the conductive layer 808 to a particular level may be more indicative of a tamper event such as a party trying to remove the seal 122/800 from the container chassis coupling device 118/200 than a change in temperature, a change in moister, a change in UV exposure, etc. As discussed above, bending or straining the conductive layer 808 by moving the seal or breaking the seal may cause a change in impedance much more rapidly than a change in the environmental conditions surrounding the seal 800.

In other embodiments, the node security engine 706 may receive sensor signals from other sensors of the sensor system 714 and/or sensor signals from sensors in other node devices or sensors positioned throughout the container via the communication system 710 and determine whether any of those sensors signals satisfy a predetermined condition indicating a container system event. In yet other examples, the node security engine 706 may receive container event notifications from other nodes included in the container 102 or other containers that are in range of the container 102 where the container event has been determined by that node device. While specific sensor signals are discussed, one skill in the art in possession of the present disclosure will recognize that other sensors that may be included in the node device 120/700 may provide a sensor signal to the node security engine 706 while still falling within the scope of the present disclosure. For example, an accelerometer may detect a sudden movement, a gyroscope may indicate improper orientation, a temperature sensor may indicate an unsatisfactory temperature, and/or other sensors discussed above that may provide a security sensor signal to the node security engine 706. For example, the temperature sensor may be used in coordination with the seal presence sensor 714b to determine whether a temperature change has occurred with a change in impedance. Other sensors may be used in coordination with the seal presence sensor 714b to determine whether other environmental factors (e.g., moister, UV) have changed, which may explain the change in impedance. In various embodiments, the security sensor signal and/or the seal sensor signal may include identifier(s) that are associated with the seal 122/800, the container chassis coupling device 200, the node device 300, the container 102, the container closure 110, and/or any other component included in the container locking system 100.

The method 1100 may then proceed to block 1104 where a container event action is performed in response to the detection of the container system event and based on the type of container system event. In an embodiment, at block 1104, if the node security engine 706 detects a container system event at block 102, the node security engine 706 may perform a container event action based on the container system event. For example, the node security engine 706 may provide a container system event notification over the communication system 710 such that a server device, another node device, a user device, and/or any other device may receive the container system event notification. The container system event notification may include the type of container system event, a time at which the container system event occurred, any relevant sensor information, and/or any other information that would be apparent to one of skill in the art in possession of the present disclosure. The container system event notification may include an identifier for the container locking system 100, the node device 120/700, an alternative node device (if the container system event was detected by a different node device than the node device 120/700), the container locking device 116, the seal 122/800, and/or any other identifier of components of the container locking system 100 or any other container information that would be apparent to one of skill in the art in possession of the present disclosure. In other examples, the container event action may include storing the container system event notification in the node database 708 until the communication interface 710 has established a link with the WAN and/or until a user device accesses the container system event notification via the communication system 710. In yet another example, the container event action may include the node security engine 706 providing an indication of the container system event via a user I/O system provided in the node device 700 (e.g., a visual indication via the visual indicator (e.g., a Light Emitting Diode (LED)), an audio indication via a speaker device, and/or other I/O system devices that would be apparent to one of skill in the art in possession of the present disclosure). While specific container event actions are described, one of skill in the art in possession of the present disclosure will recognize that other container event actions may be performed and still fall under the scope of the present disclosure such as those that are described in the U.S. Pat. No. 10,538,371 and U.S. patent application Ser. No. 16/451,879, filed on Jun. 25, 2019, entitled “Container Security System.”

Thus, systems and methods have been described that provide for a container locking system, a seal, and the detection and notification of security events. The container locking device may include a container chassis coupling device that includes one or more mounting brackets that include locking bar securing members that are configured to engage locking bars on a container or other devices that may perhaps rely on locks and chains to secure components together. The container chassis coupling device, when engaged with a container door, prevents doors on a container from opening by preventing the locking bars from being opened. A node device may be coupled to a node securing element on the container chassis coupling device and may include a node device movement sensor (e.g., a Hall effect sensor and magnet) that detects movement of the node device relative to the container. Additionally, a seal that conforms to the container locking device may be positioned over the container locking device and coupled with a seal presence sensor on the node device. The seal may include a conductive layer that when tampered with causes the node device to record a security event and, in some embodiments, report the security event to a user via a network, which may include a position (e.g., a geophysical coordinate of the container (e.g., latitude, longitude, altitude, and/or other coordinate that would be apparent to one of skill in the art) determined from a positioning system (e.g., a Global Positioning System (GPS)) included in the node device when the security event occurred. As such, the systems and method of the present disclosure provide a container closure with the container locking device that is relatively easy to add and remove from the container closure coupled to the container during a container lifecycle but difficult to counterfeit and coverup any unsecured access. The container closure node system also maintains a low profile relative to the container such that conventional tools can be used and stacking of the containers may be performed.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed:

1. A container locking system, comprising:
a container that includes a container chassis that defines a container volume and a container opening that is accessible via a first door that includes a first locking bar and a second door that includes a second locking bar; and
a container locking device that comprises:
a container chassis coupling device that comprises:
a first mounting bracket that includes a first locking bar securing element that is configured to secure the first mounting bracket to the first locking bar; and
a second mounting bracket that is slidably coupled to the first mounting bracket via a slidable coupling and that includes a second locking bar securing element that is configured to secure the second mounting bracket to the second locking bar, wherein the container chassis coupling device prevents the first locking bar and the second locking bar from being oriented from a locked orientation to an unlocked orientation when the first locking bar securing element is engaged with the first locking bar, the second locking bar securing element is engaged with the second locking bar, and a bracket lock device is in a lock orientation that prevents slidable movement of the first mounting bracket relative to the second mounting bracket; and
a node mounting device that is coupled to the first mounting bracket or the second mounting bracket and that is configured to couple a node chassis of a node device to the container chassis coupling device.

2. The container locking system of claim 1, wherein the container locking device further comprises:
a node device that includes a node chassis that is coupled to the node mounting device and the node chassis houses:
a communication system;
a processing system coupled to the communication system; and
a memory system that is coupled to the processing system and that includes instruction, that when executed by the processing system, causes the processing system to provide a container engine that is configured to:
communicate container system information associated with the container locking system via the communication system.

3. The container locking system of claim 2, wherein the node chassis includes a seal detection sensor that is coupled to the processing system and that is configured to detect a seal tampering event.

4. The container locking system of claim 3, wherein the container locking device further comprises:
a seal that is coupled to the seal detection sensor and the container locking device such that the seal causes the seal tampering event to be detected by the seal detection sensor when the container locking device is accessed to orientate the container locking device to allow the first locking bar and the second locking bar to transition from the locked orientation to the unlocked orientation.

5. The container locking system of claim 4, wherein the seal includes a breakaway tape that includes a conductive layer electrically coupled to the seal detection sensor, wherein the a least a first portion of the breakaway tape and a first portion of the conductive layer are configured to break away from a second portion of the breakaway tape and a second portion of the conductive layer when a force used to overcome an adhesive bond between the breakaway tape and the container chassis coupling device is applied to the breakaway tape.

6. The container locking system of claim 4, wherein the seal includes a conductive layer electrically coupled to the seal detection sensor, and wherein the seal detection sensor detects the seal tampering event when the conductive layer is disrupted such that the seal detection sensor detects a change in impedance that satisfies a predetermined impedance change threshold of the conductive layer.

7. The container locking system of claim 4, wherein the seal includes an ultraviolet protection layer that is located opposite the seal from an adhesive layer.

8. The container locking system of claim 1, wherein the slidable coupling includes one or more retaining clips that prevent movement of the first mounting bracket to the second mounting bracket in a direction that is orthogonal to a slidable direction.

9. The container locking system of claim 1, wherein the bracket lock device includes a knob on the first mounting bracket that is connected to one or more stoppers and that is configured to engage the one or more stoppers with the second mounting bracket such that the first mounting bracket and the second mounting bracket are in a lock orientation that prevents the slidable movement of the first mounting bracket relative to the second mounting bracket when the knob is in a first orientation and is configured to disengage the one or more stoppers with the second mounting bracket such that the first mounting bracket and the second mounting bracket are in an unlock orientation that enables the slidable movement of the first mounting bracket relative to the second mounting bracket when the knob is in a second orientation.

10. The container locking system of claim 1, wherein the node mounting device includes a node release that is configured to disengage a node from the node mounting device when activated.

11. The contain locking system of claim 1, wherein the node mounting device includes a node mounting device cover that when in a closed position defines a seal aperture with the node mounting device to receive a seal end of a seal for electrically coupling with a node device.

12. A container locking device, comprising:
a container chassis coupling device that comprises:
a first mounting bracket that includes a first locking bar securing element that is configured to secure the first mounting bracket to a first locking bar on a container; and
a second mounting bracket that is slidably coupled to the first mounting bracket via a slidable coupling and that includes a second locking bar securing element that is configured to secure the second mounting bracket to a second locking bar on the container, wherein the container chassis coupling device prevents the first locking bar and the second locking bar from being oriented from a locked orientation to an unlocked orientation when the first locking bar securing element is engaged with the first locking bar, the second locking bar securing element is engaged with the second locking bar, and a bracket lock device is in a lock orientation that prevents slidable movement of the first mounting bracket relative to the second mounting bracket; and
a node mounting device that is coupled to the first mounting bracket or the second mounting bracket and that is configured to couple a node chassis of a node device to the container chassis coupling device.

13. The container locking device of claim 12, wherein the slidable coupling includes one or more retaining clips that prevent movement of the first mounting bracket to the second mounting bracket in a direction that is orthogonal to a slidable direction.

14. The container locking device of claim 12, wherein the bracket lock device includes a knob on the first mounting bracket that is connected to one or more stoppers and that is configured to engage the one or more stoppers with the second mounting bracket such that the first mounting bracket and the second mounting bracket are in a lock orientation that prevents the slidable movement of the first mounting bracket relative to the second mounting bracket when the knob is in a first orientation and is configured to disengage the one or more stoppers with the second mounting bracket such that the first mounting bracket and the second mounting bracket are in an unlock orientation that enables the slidable movement of the first mounting bracket relative to the second mounting bracket when the knob is in a second orientation.

15. The container locking device of claim 12, wherein the first locking bar securing element includes a first longitudinal securing element that prevents the first locking bar securing element from being moved along a longitudinal axis of the first locking bar, and wherein the second locking bar securing element includes a second longitudinal securing element that prevents the first locking bar securing element from being moved along the longitudinal axis of the first locking bar.

16. A container seal, comprising:
a breakaway tape that comprises:
an adhesive layer;
a body layer that is coupled to the adhesive layer; and
a conductive layer that is at least one of being disposed between the body layer and the adhesive layer, disposed within the body layer or adhesive layer, or coupled to the body layer such that the body layer is between the conductive layer and the adhesive layer, wherein the body layer includes a material that is configured to cause a first portion of the body layer to break away from a second portion of the body layer when a force to overcome an adhesive bond between the adhesive layer and a surface to which the breakaway tape is configured to adhere to is applied to the breakaway tape.

17. The container seal of claim 16, wherein the breakaway tape further comprises:
an ultraviolet resist layer that provided opposite the body layer of the breakaway tape from the adhesive layer such that the body layer and the conductive layer are between the adhesive layer and the ultraviolet resist layer, wherein the ultraviolet resist layer is configured to prevent degradation of the breakaway tape from ultraviolet radiation.

18. The container seal of claim 16, wherein the conductive layer is coupled to one or more electrical contacts that are exposed via the adhesive layer.

19. The container seal of claim 17, wherein the conductive layer is configured such that the conductive layer provides a first impedance detectable via the one or more electrical contacts and the breakaway tape is adhered to a surface, and a second impedance detectable via the one or more electrical contacts when the breakaway tape is at least one of bent, ripped, drilled, or compressed.

20. The container seal of claim 16, wherein the breakaway tape further comprises a liner layer that is coupled to the adhesive layer and a force required to remove the liner layer from the adhesive layer is less than the force that causes the first portion of the body layer to break away from the second portion of the body layer.
